(19) United States
(12) Patent Application Publication
(10) Pub. No.: US 2004/0204778 A1
(43) Pub. Date: Oct. 14, 2004

(54) Method for persisting SNMP MIB data in files

(76) Inventors: Harish Lalapeth, Haryana (IN); Salim Uddin, New Delhi (IN)

Correspondence Address: NIXON & VANDERHYE, PC, 1100 N GLEBE ROAD, 8TH FLOOR, ARLINGTON, VA, 22201-4714, US

(21) Appl. No.: 10/336,838

(22) Filed: Jan. 6, 2003

(51) Int. Cl. G05B 15/00

(52) U.S. Cl. 700/83

(57) ABSTRACT

SNMP MIB data is stored in a persistence file where the storage format provides representations of SNMP scalar and table objects and is independent of SNMP protocol.

### FIELD OF THE INVENTION

The present invention relates to a method for storing SNMP MIB data in persistence file.

### BACKGROUND OF THE INVENTION

In any network system, a significant task of any network administrator is to manage network level disruptions and enable recovery within a limited time period to ensure continuity in operations. Generally, such network level disruptions are managed by the periodic monitoring of the network element (NE). In the event of a disruption, the network element is recovered by bringing the element into a stable state that it was in before the crash, including its element state and configuration.

The most widely used protocol in network management is the SNMP protocol. SNMP MIB provides the schema for the management data that needs to be configured at the network element. With network elements deployed in Highly Available and Carrier Grade environment for both telecom and enterprise networks, the emphasis is on bringing the network elements to a configured state in the least amount of time. The Managing Entity (ME) manages the configuration of the NE. Although the configuration of the network element could be stored in the memory (RAM) of the Managing Entity (ME), if the application or the system as a whole goes down the entire latest configuration is lost. When the system is brought up once again the user has to configure the system manually from scratch. To avoid manual configuration of the system later, and to get the system up and running in a minimum time the concept of persistence was introduced. Once the system comes up the ME reads the persistence file and updates its memory with the latest MIB data values, and then starts configuring the network element with these latest values. This necessitates automatic download of configuration to these network elements on startup. Any runtime updates of configuration is also reflected in the persistent file.

Different methods exist for storing SNMP MIB data in persistence file. Many network management related tools require SNMP MIB(s) as input. It could be a MIB browser or a SNMP agent development tool. The configuration profiles used by the NM applications can either be manager centric or agent centric. High Availability platforms remove the dependency on an external manager, hence all configuration profiles are located on the same platforms. For example, the configuration profiles could have been reconciled and downloaded from the external manager.

Emanate is a popular SNMP agent toolkit, uses a persistent strategy of SNMP MIB data configuration. There are library functions provided by the EMANATE toolkit to support persistence storage. The persistence files generated by these functions are in proprietary format and can only be read by the library functions provided by EMANATE toolkit. The file generated by EMANATE is in readable ASCII format. A user can modify this file, if he is aware of the MIB.

In a typical example the contents of the file would be

# Entry type: employeeConfigurationEntry

# Entry format: integer

# octetString

# integer

# integer

# integer

employeeConfigurationEntry 1 48:53:53 25 829 1

employeeConfigurationEntry 2 53:41:4c:49:4d 25 999 1

employeeConfigurationEntry 3 4d:55:4e:49 25 1000 1

Defining what to store in the configuration profile (ASCII file) is statically defined (pre-defined) at compile time and needs to be embedded in the agent code. Run time profile generation not possible. Storage format is toolkit specific and cannot be customized to suit user requirement. There is no automation of profile generation. The values for all column entries, for a pre-defined table object, have to be specified. Hence cannot support optional and mandatory columnar attributes in a table object.

MIB Browser takes SNMP MIB as input and displays the management tree. User can browse through the tree to retrieve values from a remote SNMP agent or set particular values. However, there is no persistence of data. Details can be found at www.adventnet.com. Schema conversion tools have been developed by some organizations in house that provide mapping of SNMP MIB schema to SQL, CORBA IDL etc. Details can be found at http://www.ibr.cs.tu-bs.de/projects/libsmi/download.html

U.S. Pat. No. 6,266,672 discloses a persistence storage method and system that process a storage mechanism-independent query. The method and system identifies at least one persistence storage mechanism that is capable of providing data for satisfying the query from among at least two persistence storage mechanisms. Data satisfying the query is derived from the identified persistence storage mechanisms.

U.S. Pat. No. 6,411,954 discloses a method and apparatus for persisting object-oriented data. Persistent storage is established for a working data set and a committed data set. The areas for the working and committed data sets are used for storage of the persistent data objects. After a persistent data object is updated in computer memory, the updated version is written to the working data set. Then, references to the working data set and the committed data set are switched, whereby the working data set becomes the committed data set and the committed data set becomes the working data set.

U.S. Pat. No. 6,275,912 discloses a system and method for efficiently storing data items to a storage device, such as hard disk, uses a data collector and a data writer running in different threads. A data source produces a stream of write requests to write data items to the storage device. The write requests are passed to the data collector, which accumulates, orders, and consolidates the write requests in a data structure. The data writer handles the operation of writing data to the storage device. The ordered and consolidated data items are then given to the data writer, which writes them to the storage device.

U.S. Pat. No. 5,999,948 discloses dynamic configuration forms in network management software One or more form descriptions are expressed in the form description language (FDL) and are entered into an FDL file. The FDL file is then registered with a dynamic form software module using dynamic forms API. Upon registration, the file is parsed and software “specification” objects containing a data from the file or added to the internal catalogue of compiled form descriptions. When the application requests a form to be displayed, the dynamic form software finds the entry for the form in the catalogue, constructs the form using the information from the specification objects, and displays the information to the user. The form construction process includes the selection of widgets, the binding of each widget to a data source, the layout and alignment of all widgets, and the construction of rule objects that respond to the user interaction with the form and validate the users input.

U.S. Pat. No. 5,819,042 discloses a Method and apparatus for guided configuration of unconfigured network and internetwork devices. Computer-implemented method and apparatus and associated for constructing a network configuration map comprised of at least two interconnected network entities selected from a series of network entities. A series of configuration scripts, each corresponding to one of the series of network entities include a first section comprised of a first portion containing an icon file for generating an icon representative of the corresponding one of the series of network entities. A second portion containing a set of connection rules for the corresponding one of the series of network entities and a second section containing a series of executable instructions for constructing a configuration file for the network entity. A first software module constructs the network configuration map by generating workspace, placing first and second icons on the workspace in response to first input received from a user interface. Connection of icons is done if set of connection rules contained in second portion of the corresponding configuration scripts permit connection there between. A second software module then executes the series of instructions contained in the second section of the configuration script to construct a configuration file, suitable for upload to the network device to enable configuration thereof, for a selected one of the connected icons.

U.S. Pat. No. 5,684,988 discloses an apparatus for acquiring a plurality of values from an agent on a network is provided. The apparatus may be accessed through a predefined interface by various network management station applications. Because the apparatus is independent from the network management applications, the functionality provided by the apparatus need not be duplicated in each network management station application. The apparatus generally includes an agent identification unit, a display mechanism, a database access unit, a storage device and an information retrieval unit. The storage device stores a database containing data representing agents, management information bases, objects and attribute groups. When a network management station application requires values from an agent, the network management station application sends the apparatus a signal identifying the agent and specifying an information category, such as performance, status, or diagnostic. The agent identification unit identifies the type of the agent. The database access unit accesses the database to determine a plurality of objects, which correspond to the specified information category according to the type of the agent. The information retrieval unit sends an information request to the agent based on the plurality of objects determined by the database access unit, and receive a response containing the plurality of values from the agent. The plurality of values is sent to the display unit, which displays the values visually in a pop-up window.

U.S. Pat. No. 5,684,945 discloses a system and method for maintaining performance data in a data processing system. A library of performance monitor recordings is maintained according to pathologies. The library is indexed to provide a facility to diagnosis poorly performing data processing systems, by capturing performance statistics and comparing these statistics against known problematic statistics. Remote diagnosis can easily be provided by a user capturing a performance session, saving to a file, and transferring the file to a central facility for comparison against its pathological libraries.

### OBJECTS OF THE INVENTION

It is an object of the invention to provide a method for persisting SNMP MIB data of different storage formats in files and an apparatus therefor. Tis invention overcomes the disadvantages of prior art systems and enables easy recovery of network element state and configuration data in reduced time.

### SUMMARY OF THE INVENTION

The above and other objects of the invention are achieved by the system of the invention wherein the storage format of the persistent file provides representation of SNMP scalar and table objects, and is independent of SNMP protocol. The storage format of SNMP MIB data is concise (store only what is required to be stored), scalable (support multiple instances in SNMP Table objects), and user friendly (readable).

It is an embodiment of the invention that it provides an apparatus (SNMP MIB(s) and a GUI based tool) for generating SNMP MIB based configuration profiles, of different storage formats, in persistent files

In one embodiment of the invention, the file can be edited before deployment depending on site specifics.

It is an embodiment of the invention that the persistence file storage format is SNMP agent toolkit independent.

In another embodiment of the invention, the persistent file storage format is based on tags used to identify SNMP objects, namely scalars and tables.

It is an embodiment of the invention, the data stored in the persistence file are validated for data type and range checks as specified in the SNMP MIB

In another embodiment of the invention consistency is provided across MIB data stored in persistent files in different storage formats

In yet another embodiment of the invention, options are provided to select and store MIB objects required for a particular deployment.

It is an embodiment of the invention that it provides configuration profiles to address bulk provisioning requirements.

In another embodiment of the invention multiple configuration profile(s) can be generated dynamically to suit a particular deployment requirement.

In another embodiment of the invention SNMP MIB based configuration profile(s) generated for a given network element, can be used by non-SNMP applications.

In another embodiment of the invention, the persistent file storage format facilitates reading and writing of the file by the ME.

### BRIEF DESCRIPTION OF THE ACCOMPANYING DRAWINGS

FIG. 1 illustrates the work-flow of the system according to the invention.

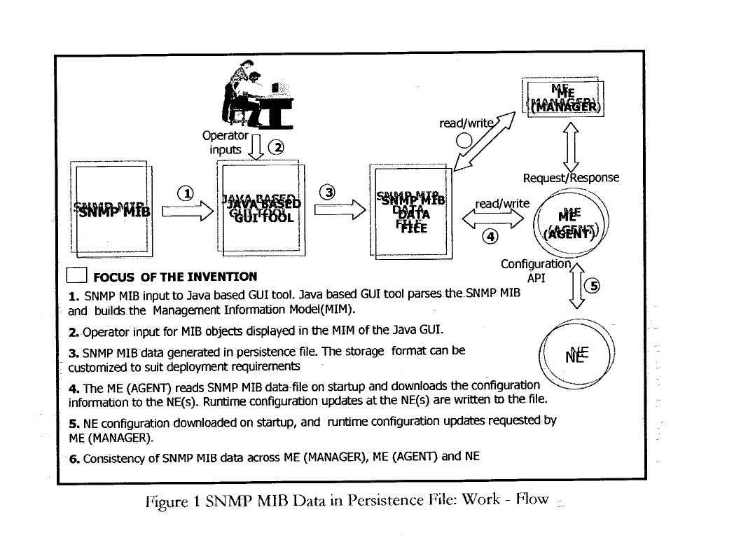

FIG. 2 illustrates persistent file usage by SNMP and non-SNMP ME

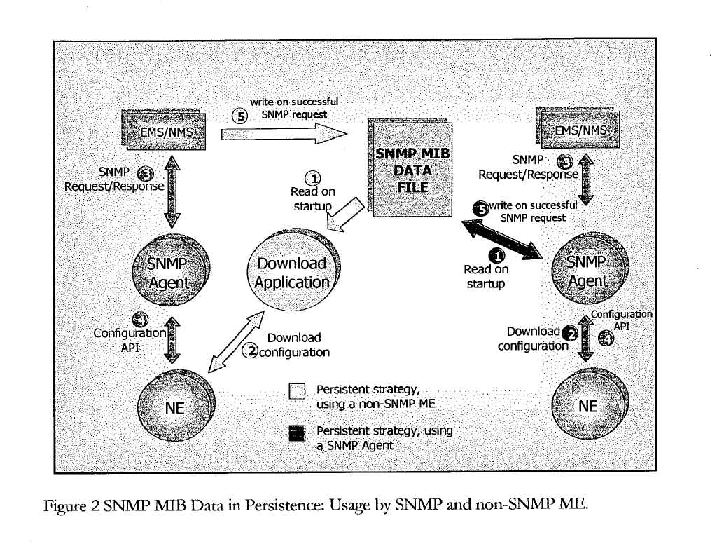

FIG. 3 illustrates SNMP MIB based configuration profiles and their usage across ME(s).

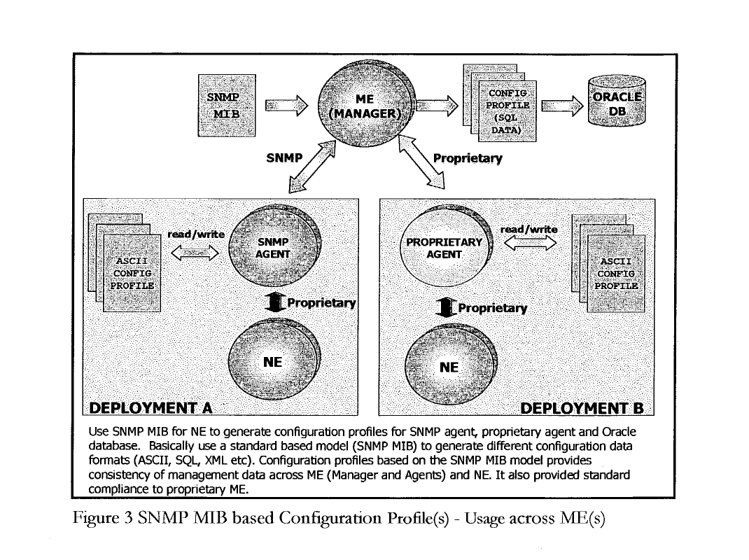

### DETAILED DESCRIPTION OF THE INVENTION

To facilitate recovery of management data, the management information is typically stored in persistent file. There could be different methods of storing the management data. The present invention provides the following features, which suits different deployment requirements of a NE and improves the time lag in recovery of stored data

1. Automating the procedure of generating the persistent file in different storage format(s).

2. Consistency of data stored in the different storage format(s)

3. Storage of only relevant management information (store what is required for a given NE deployment).

4. Build run time configuration profile to provide bulk provisioning data

5. SNMP MIB based configuration profile generated from a standard model (SNMP MIB) can be used by non-SNMP ME.

6. Storage format of persistent file has SNMP objects written at unique file offsets. This facilitates reading and writing of file.

In the system of the invention, consider a situation where a service provider has obtained network equipment with associated SNMP manageability support for easy integration with the service provider's Element Management System (EMS) or Network Management System (NMS). All the equipment in the service provider network has a mechanism for recovery of configuration data in place through persistence. The new network equipment to be deployed does not have any such mechanism in place. All that was provided was SNMP agent and the equivalent SNMP MIB. In order to apply a similar recovery mechanism to the newly procured network elements, SNMP MIB is used as an input to build the recovery mechanism for the new NE. The SNMP MIB provides the configuration model for the equipment. Data representation of the model to suit a particular deployment of the NE in generated in a persistent file as a configuration profile. This file could be read by the SNMP agent on startup and downloaded to the NE. Successful dynamic SNMP updates can be written to this file. This additional feature can be incorporated with the SNMP agent in case the agent source is made available.

Data consistency is taken care of as the configuration information is based on standard model and the GUI tool provides data validation and range checking as specified in the SNMP MIB. The deployment setup also can decide which of the SNMP MIB objects needs to be stored in the file. In typical NM application configuration data profiles are typically stored at the manager in a database. After every successful update at the remote Network Element this database is updated. A centralized manager centric configuration is distribution is typically used in large systems.

However when we talk about Network Elements and High Availability, it is required that the configuration of the NE platforms, especially during the booting of the Network Element, be independent of the external manager. Otherwise multiple points of failure are created since the Network Element may not be able to come up if the external manager is down.

The requirement is to store the configuration profile at the Network Element. During boot-up the Network Element could reconcile with the external manager to download the latest configuration profile. Once the configuration profile is available at the network element, on boot-up the configuration information is read from the file and downloaded to the network element components. Hence the network element comes up to a configured state without any operator intervention.

The configuration profiles stored at the network element are defined in different proprietary formats. Normally these formats are manually prepared and not based on a standard management model.

The present invention offers several advantages over existing systems of persistence in data format. For example automation of configuration profile generation is missing in the prior art Customized generation of configuration profile format (ASCII format, XML format or Database (PL/SQL format), is enabled with the present invention. The emphasis in the present system is that only required data is stored thereby enabling flexibility to the user to define and store site specific data. This includes support for optional and mandatory columnar attributes in a SNMP table object. Dynamic generation of configuration profiles based on the standard SNMP MIB model is provided in the invention. The system and tools of the invention are based on the SNMP MIB model and is third party tool independent. Data stored in the configuration profile is checked for syntax and range by the invention. The data stored in the configuration profile developed through this invention is management protocol independent and toolkit independent. The persistence file storage format developed through this invention facilitates reading and writing of file by the ME, as the SNMP MIB objects are written at unique file offsets.

We claim:

1. A method for storing SNMP MIB data in persistence file wherein the storage format of the persistent file provides representation of SNMP scalar and table objects and is independent of SNMP protocol.

2. A method as claimed in claim 1 wherein the persistence file is editable before deployment depending on site specifics.

3. A method as claimed in claim 1 wherein a GUT based tool is provided to take SNMP MIB(s) as input and generate configuration profiles in format(s) suitable for particular deployment.

4. A method as claimed in claim 1 wherein the GUI based tool validates SNMP MIB data stored in different storage formats, on data type and range checks defined in the SNMP MIB.

5. A method as claimed in claim 1 wherein the storage format is based on tags used to identify SNMP objects.

6. A method as claimed in claim 5 wherein the SNMP objects are selected from scalars and tables.

7. A method as claimed in claim 3 wherein new values and updates for the SNMP MIB objects, to be stored in the persistent file is done through the GUT based tool.

8. A method as claimed in claim 2 wherein user options are provided through a GUI based tool to selectively store SNMP MIB objects as required for a particular deployment.

9. A method as claimed in claim 3 wherein user options are provided through the GUT based tool to selectively store SNMP MIB objects as required for a particular deployment.

10. A method as claimed in claim 1 wherein the storage format is SNMP agent toolkit independent.

11. A method as claimed in claim 1 wherein the storage format uses a consistent notation to differentiate between scalar and tabular objects of the SNMP MIB.

12. A method as claimed in claim 3 wherein the default tags used for the storage format can be changed to user defined values through the GUT based tool.

13. A method as claimed in claim 5 wherein the default tags used for the storage format can be changed to user defined values through the GUT based tool.

14. A method as claimed in claim 1 wherein consistency of data is provided across configuration profiles stored in different storage formats

15. A method as claimed in claim 1 wherein the configuration profiles address bulk provisioning requirements

16. A method as claimed in claim 1 wherein the SNMP based configuration profile(s) generated for a given network element is usable by non-SNMP applications.

17. A method as claimed in claim 1 wherein multiple configuration profile(s) are generated dynamically to suit a particular deployment requirement

18. A method as claimed in claim 1 wherein the storage format facilitates reading and writing of file by writing a SNMP MIB object at unique file offset.
